(19) United States
(12) Patent Application Publication
(10) Pub. No.: US 2026/0138301 A1
(43) Pub. Date: May 21, 2026

(54) TABLE SAW MICRO ADJUSTMENT JIG

(71) Applicant: Paul R. Stone, Provo, UT (US)

(72) Inventor: Paul R. Stone, Provo, UT (US)

(21) Appl. No.: 19/384,370

(22) Filed: Nov. 10, 2025

Related U.S. Application Data
(60) Provisional application No. 63/722,142, filed on Nov. 19, 2024.

(51) Int. Cl. B27B 27/10

(52) U.S. Cl. CPC B27B 27/10

(57) ABSTRACT

A table saw micro adjustment jig attaches magnetically to a table saw fence guide rail and uses an extended low profile bar to contact the fence carriage and adjust the position of the fence. A threaded adjustment mechanism extends between an adjuster mounting base and adjuster base to extend or retract the bar in a predictable and controlled manner, allowing precise movement of the table saw fence.

### PRIORITY

The present application claims the benefit of U.S. Provisional Application Ser. No. 63/722,142, filed Nov. 19, 2024, which is herein incorporated by reference in its entirety.

### THE FIELD OF THE INVENTION

The present invention relates to table saws. In particular, examples of the present invention relate to a table saw micro adjuster that allows for precise positioning of the table saw fence.

### INTRODUCTION

Table saws are commonly used commercially and by hobbyists for cutting wood and other materials in order to make furniture, cabinets, and other items. The present invention provides a micro adjuster that allows a person to make minute controlled adjustments to the positioning of the table saw fence and thereby precisely control the width of the cut material. The micro adjuster is used to eliminate poorly fitting joints and the resulting problems such as glue lines and inaccurately made furniture.

### BRIEF DESCRIPTION OF THE DRAWINGS

Non-limiting and non-exhaustive examples of the present invention are described with reference to the following figures, wherein like reference numerals refer to like parts throughout the various views unless otherwise specified.

FIG. 1 is a drawing of an example table saw fence.

FIG. 2 is a drawing of a portion of the table saw fence and table saw.

FIG. 3 is a drawing of a table saw micro adjustment jig.

FIG. 4 is a drawing of the micro adjustment jig mounting base.

FIG. 5 is a drawing of the bottom of the micro adjustment jig mounting base.

FIG. 6 is a drawing of the micro adjustment jig extension bar and adjuster base.

FIG. 7 is a drawing of the micro adjustment jig attached to the table saw.

FIG. 8 is a drawing of the micro adjustment jig attached to the table saw.

FIG. 9 is a drawing of the micro adjustment jig.

FIG. 10 is a drawing of the micro adjustment jig.

FIG. 11 is a drawing of the micro adjustment jig.

FIG. 12 is a drawing of the micro adjustment jig attached to the table saw.

FIG. 13 is a drawing of the micro adjustment jig attached to the table saw.

Corresponding reference characters indicate corresponding components throughout the several views of the drawings. Unless otherwise noted, the drawings have been drawn to scale. Skilled artisans will appreciate that elements in the figures are illustrated for simplicity and clarity. For example, the dimensions of some of the elements in the figures may be exaggerated relative to other elements to help improve understanding of various examples of the present invention. Also, common but well-understood elements that are useful or necessary in a commercially feasible embodiment are often not depicted in order to facilitate a less obstructed view of these various embodiments of the present invention.

It will be appreciated that the drawings are illustrative and not limiting of the scope of the invention which is defined by the appended claims. The examples shown each accomplish various different advantages. It is appreciated that it is not possible to clearly show each element or advantage in a single figure, and as such, multiple figures are presented to separately illustrate the various details of the examples in greater clarity. Similarly, not every example need accomplish all advantages of the present disclosure.

### DETAILED DESCRIPTION

In the following description, numerous specific details are set forth in order to provide a thorough understanding of the present invention. It will be apparent, however, to one having ordinary skill in the art that the specific detail need not be employed to practice the present invention. In other instances, well-known materials or methods have not been described in detail in order to avoid obscuring the present invention.

In the above disclosure, reference has been made to the accompanying drawings, which form a part hereof, and in which are shown by way of illustration specific implementations in which the disclosure may be practiced. It is understood that other implementations may be utilized and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, such feature, structure, or characteristic may be used in connection with other embodiments whether or not explicitly described. The particular features, structures or characteristics may be combined in any suitable combination and/or sub-combinations in one or more embodiments or examples. It is appreciated that the figures provided herewith are for explanation purposes to persons ordinarily skilled in the art.

As used herein, “adjacent” refers to near or close sufficient to achieve a desired effect. Although direct contact is common, adjacent can broadly allow for spaced apart features. As used herein, the singular forms “a,” and, “the” include plural referents unless the context clearly dictates otherwise.

As used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases depend on the specific context. However, generally speaking the nearness of completion will be such as to have the same overall result as if absolute and total completion were obtained. The use of “substantially” is equally applicable when used in a negative connotation to refer to the complete or near complete lack of an action, characteristic, property, state, structure, item, or result. For example, a composition that is “substantially free of” particles would either completely lack particles, or so nearly completely lack particles that the effect would be the same as if it completely lacked particles. In other words, a composition that is “substantially free of” an ingredient or element may still actually contain such item as long as there is no measurable effect thereof.

As used herein, the term “about” is used to provide flexibility to a number or numerical range endpoint by providing that a given value may be a significant digit above or a significant digit below the number or endpoint.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Dimensions, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 to about 5” should be interpreted to include not only the explicitly recited values of about 1 to about 5, but also include individual values and sub-ranges within the indicated range.

Table saws are used by many individuals to cut wood and create cabinets, furniture, and other items. The table saw includes a horizontal table that is held on a stand, a motor and electronic components within the stand, and a circular blade that extends vertically through a slot in the table and is driven by the motor. The plane of the circular blade extends fore and aft. As the circular blade is suited to making straight cuts, table saws include a fence that may be attached to the table saw to guide the material through the saw.

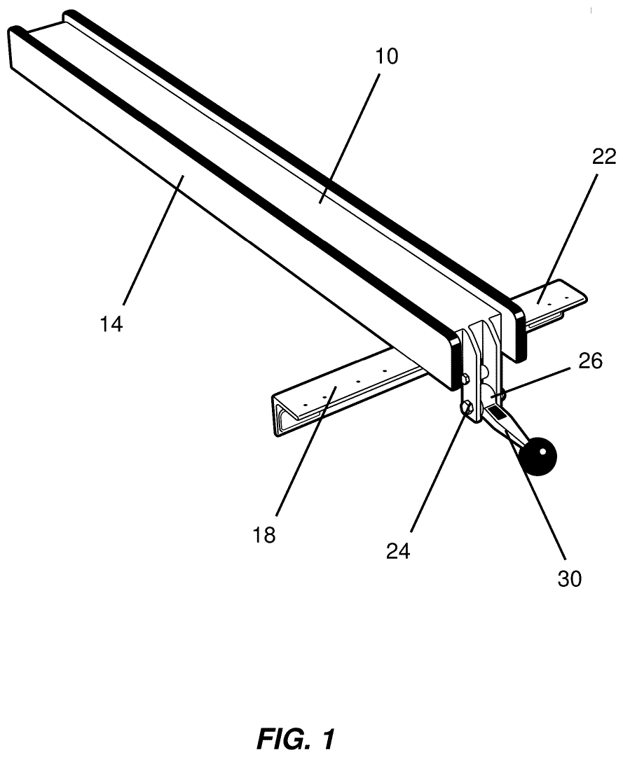

FIG. 1 shows an example table saw fence 10. The fence 10 includes an elongate straight fence bar 14 that provides a guide surface for material being cut by the table saw. The fence bar 14 is typically includes left and right sides that are straight, smooth, and parallel so that both sides of the fence may be used as needed. The fence bar 14 is attached to a T shaped fence head 18. The fence head 18 includes a guide carriage or bar 22 that extends beyond the fence bar 14 left and right and is perpendicular to the fence bar 14. The guide carriage 22 is used to position the fence 10 laterally along a table saw table and secure the fence to the table saw table. The example fence 10 includes a guide carriage 22 that is made of steel angle. The fence 10 also include a clamp 24 that is used to clamp the fence 10 at a desired location on a table saw. The example clamp 24 includes a cam lobe 26 that is attached to the clamp body and is rotated by a clamp handle 30 to clamp a fence guide rail between the carriage 22 and the clamp mechanism to lock the fence in place on the table saw.

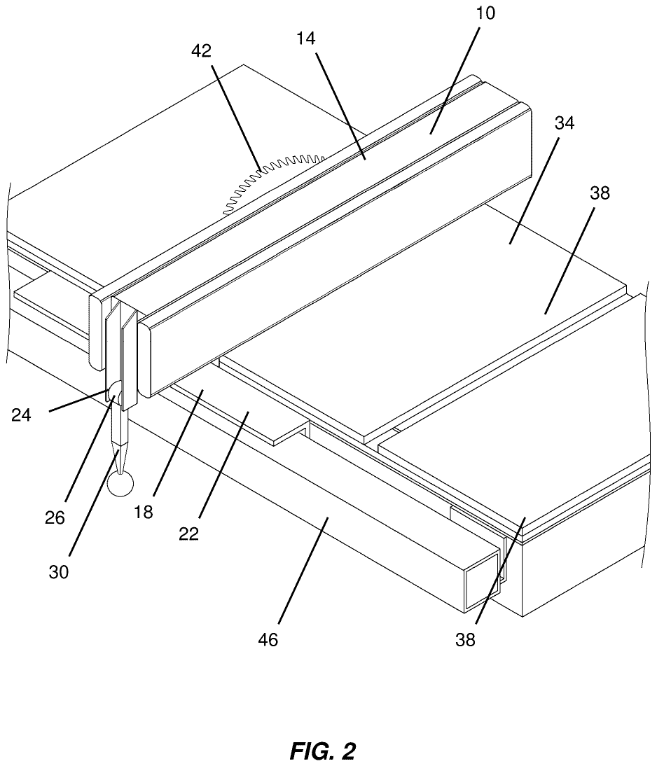

FIG. 2 shows a portion of the fence 10 attached to a table saw 34. For convenience, standard parts of the table saw such as the stand, motor, or switch are not shown but are understood to form part of the table saw. The fence 10 is typically used with the table saw 34 to allow a user to create straight cuts in a desired material. The table saw 34 includes a flat horizontal table 38 that supports material being cut with the table saw 34. A circular saw blade 42 is driven by a motor and electrical components (not shown) and used to cut a desired material as a user moves the material across the table 38 and past the blade; typically with the material in contact with the fence 10. The table saw 34 is supported by a stand (not shown). A fence guide rail 46 extends laterally across the front of the table saw table 38. The fence guide rail 46 extends across the entire front width of the table saw including across any table extension, and may often be between about 3 feet wide and about 8 feet wide depending on the width of the table 38. The fence guide rail 46 is positioned about one half inch below the upper surface of the table saw table 38. The example fence guide rail 46 is square steel tubing that is about 2 inches square with about 0.1 inch wall thickness. The fence 10 is attached to the table saw 34 by clamping the guide rail 46 between the fence guide carriage 22 and the clamp 24. The clamp 24 pushes against the guide rail 46 and holds the guide rail 46 between the fence carriage 22 and the clamp 24 to prevent movement of the fence 10 relative to the guide rail 46 and table saw 34. This style of table saw fence 10 includes a low profile fence carriage 22. The fence carriage 22 is made of metal angle (typically steel or aluminum) that is about two inches wide and tall and between about one eighth and about one quarter of an inch thick. When the fence 10 is attached to the table saw 34, the upper, horizontal leg of the fence carriage angle 22 extends across an upper surface of the guide rail 46 and the lower, vertical leg of the fence carriage angle 22 extends across a rear surface of the guide rail 46. When the fence 10 is attached to the table saw fence guide rail 46, the top surface of the fence guide carriage 22 sits about 0.3 inches above the guide rail 46 and about 0.3 inches below the upper surface of the table 38. The top surface of the carriage 22 remains below the top surface of the table 38 so that material being cut may slide across the table 38 without contacting the carriage 22 such that the carriage 22 does not interfere with an operator using the table saw 34 to cut the material. In use, the position of the fence 10 is adjusted by unlocking the clamp 24, moving the fence 10 laterally to a desired location, and locking the clamp 24 to secure the fence 10 to the table saw 34. A ruler or piece of wood may be placed between the fence bar 14 and the blade 42 to assist in positioning the fence 10. Adjusting the fence to a precise position is difficult.

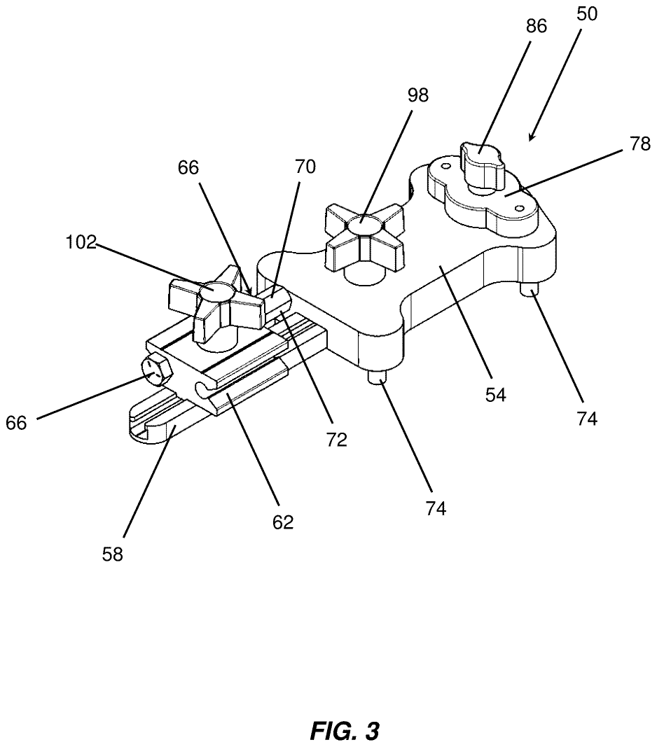

FIG. 3 shows a micro adjustment jig 50 that may be used to more precisely adjust the position of the table saw fence 10. The design of the micro adjustment jig 50 permits it to be used universally with the example style of table saw fence 10 as well as with nearly all other common styles of table saw fences. The micro adjustment jig 50 is beneficial to users as it allows for precise adjustment of the table saw fence 10. The fence 10 is heavy and requires some force to slide across the table saw for adjustment. Commonly, people push or tap against the fence 10 to attempt to move the fence 10 laterally a small amount to adjust the width of the cut between the blade 42 and the fence bar 14. This is imprecise, and the friction in moving the fence 10 often causes the fence to jump and move more than intended, making it difficult to make accurate adjustments of the fence 10 and achieve precision cuts with the table saw 34. The micro adjustment jig 50 allows a person to maintain a fixed point of reference while adjusting and using the table saw 34 and adjusting the table saw fence 10. The micro adjustment jig 50 need not be removed to cut material with the table saw; allowing precise repeated adjustment of the table saw fence 10.

The micro adjuster 50 includes a main body 54 that forms a mounting base that attaches to the table saw fence guide rail 46. A low profile extension bar 58 such as a section of T-track 58 is attached to the mounting base and extends from the mounting base 54. The T-track 58 is a rectangular bar with a central slot shaped like an inverted T extending through the length of the bar. The slot receives a bolt head to fasten the mounting base 54 to the T-track 58. The T-track 58 slides within a mounting channel formed in the bottom of the mounting base 54 and may be extended or retracted from the mounting base 54 and used to adjust the position of the table saw fence. An adjuster base 62 is attached to the section of the bar/T-track 58 that extends laterally from the mounting base 54. The adjuster base 62 includes a threaded adjustment screw 66 that is attached to the adjuster base 62. The example adjustment screw 66 is a bolt that passes through a hole in the adjuster base 62 and is attached with a nut 68. A rotatable end stop 70 is attached to the adjustment screw 66 and the adjustment screw 66 and rotatable end stop 70 form a threaded adjustment mechanism 72. The end stop 70 is threaded internally and the end stop 70 rotates on the adjustment screw threads to move the end stop 70 laterally and thereby extend or retract the end stop 70 along the adjustment screw 66 and relative to the adjustment base 62. In using the micro adjustment jig 50, the adjustment mechanism 72 extends from the adjustment base 62 and the distal end of the adjustment mechanism 72 contacts the mounting base 54. Extending or retracting the end of the adjustment mechanism 72 via the end stop 70 changes the distance between the mounting base 54 and the adjuster base 62 and thereby changes the distance by which the T-track 58 extends from the mounting base 54.

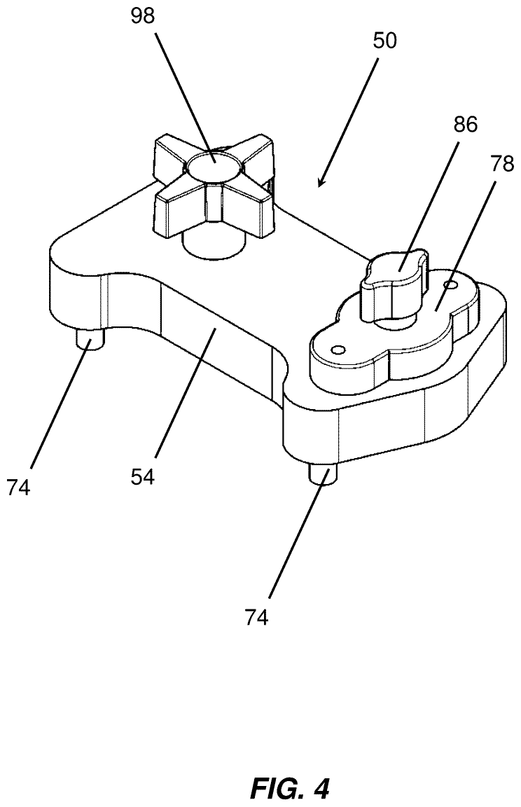

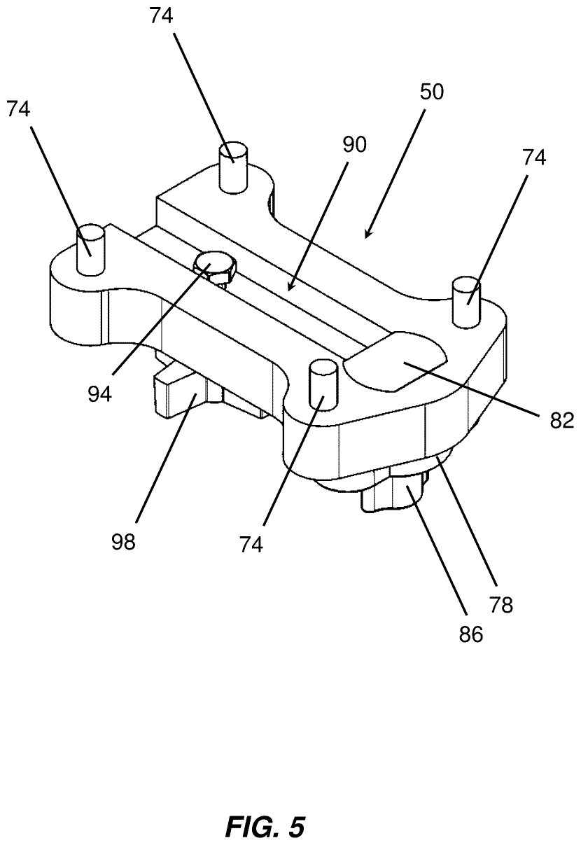

FIG. 4 shows a top view of the mounting base 54 and FIG. 5 shows a bottom view of the mounting base 54. The mounting base 54 includes a lower alignment guide 74 that extends downwardly from the bottom of the mounting base to contact the fence guide rail 46 and align the mounting base 54 longitudinally along the fence guide rail 46 during use of the micro adjustment jig 50 so that the extension bar 58 is parallel to the guide rail 46. In the example micro adjustment jig 50, the alignment guide 74 includes posts 74 that extend down from the bottom of the mounting base 54. The example jig 50 includes two pairs of posts 74 that are positioned along each side of the mounting base 54, with each pair of posts being positioned along a side of the jig 50. The posts 74 are spaced apart from each other along the length of the mounting base 54 and positioned near the corners of the mounting base 54. The pairs of posts 74 are positioned along a line that is parallel to the T-track 58 and the posts 74 are spaced apart far enough from each other to allow a user to easily position the mounting base 54 along the fence guide rail 46 and parallel to the guide rail 46 by using the posts 74 to contact the side of the fence guide rail 46. The sets of posts 74 are spaced apart on the two sides of the mounting base 54 with enough space to receive the guide rail 46 between the posts 74. An elongate wall or shoulder may be used instead of a pair of posts 74 to align the mounting base 54 to the fence guide rail 46 if desired. Having an alignment guide 74 on both sides of the mounting base 54 allows the jig 50 to be used more easily in a left or right hand configuration.

The mounting base 54 includes a switchable magnetic clamp 78 that is mounted to one end of the mounting base 54 and used to secure the mounting base 54 to the table saw 34. The magnetic clamp 78 includes a housing 82 that extends through the mounting base 54 and positions the active end of the magnetic clamp 78 at the bottom surface of the mounting base 54 where the end of the magnetic clamp can contact or be placed in close proximity with the steel fence guide rail 46. The magnetic clamp also includes a rotatable switch handle 86 that extends from the top of the magnetic clamp 78. The example magnetic clamp 78 includes two polarized cylindrical magnets held within the housing. The housing 82 will conduct magnetic flux from the magnets. Each of these magnets is a horizontally positioned disc shape with the cylindrical axis positioned vertically in alignment with the housing 82 and handle 86. Each magnet has its north-south poles aligned horizontally perpendicularly to the cylindrical axis. One magnet is positioned above the other magnet along the cylindrical axis. The bottom magnet is held in a fixed position within the housing 82. The top magnet is attached to the top switch 86 and may be rotated 180 degrees by rotating the switch 180 degrees. When the top magnet is rotated so that its north south-poles are positioned opposite the north-south poles of the bottom magnet, the magnetic field generated by the magnets is shunted internally and the magnetic clamp 78 does not emit a significant magnetic field to attract external magnetically attracted materials. When the top magnet is rotated so that its north south-poles are positioned in the same direction as the north-south poles of the bottom magnet, the magnetic field generated by the magnets extends out of the housing 82 and magnetically attracted materials such as steel are held against the housing 82 of the magnetic clamp 78 by the magnets. Thus, with the switch in an off position, the mounting base 54 is not held against the table saw fence guide rail 46. With the switch rotated to the on position, the mounting base 54 is held securely against the table saw fence guide rail 46 or table 38 and the mounting base 54 is not permitted to move relative to the fence guide rail 46. Saws with a non-magnetic fence guide rails 46 such as those with aluminum guide rails may use a mechanical clamp to attach the mounting base 54 to the saw.

The bottom of the mounting base 54 includes a longitudinal slot 90 that receives the T-track 58. The slot 90 is long enough to allow the T-track 58 to slide longitudinally along the slot 90 to change the distance by which the T-track extends from the mounting base 54. A hand screw or a bolt and threaded nut/knob are used to attach the T-track 58 to the mounting base 54. In the example, a bolt 94 extends through a hole in the mounting base 54 with the bolt head is positioned inside the slot 90 and the threaded end of the bolt 94 extending above the top of the mounting base 54. The bolt head is placed in the central slot of the T-track 58 when the T-track is inserted into the slot 90. A threaded knob 98 is attached to the threaded end bolt and can be used to secure the T track within the slot 90. The threaded knob 98 is typically adjusted to hold the T-track within the slot 90 while allowing the T-track 58 to slide easily within the slot 90 to adjust the overall length of the micro adjuster 50 and thereby adjust the position of the table saw fence 10. If the threaded knob 98 is tightened, the T-track is held in a fixed position within the slot 90. This may be used when the micro adjuster 50 has been set up for a particular task and it should not be adjusted until the task is completed.

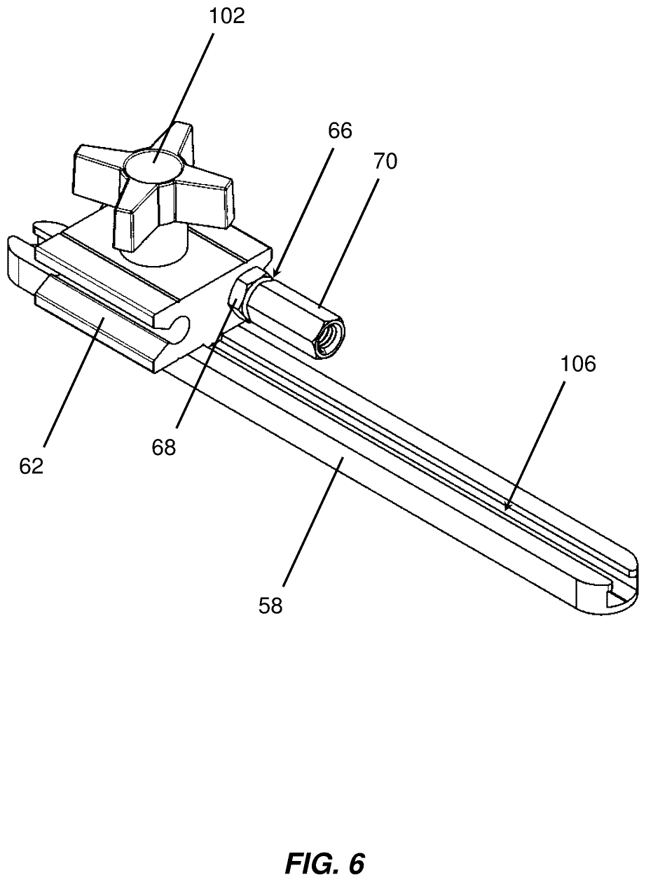

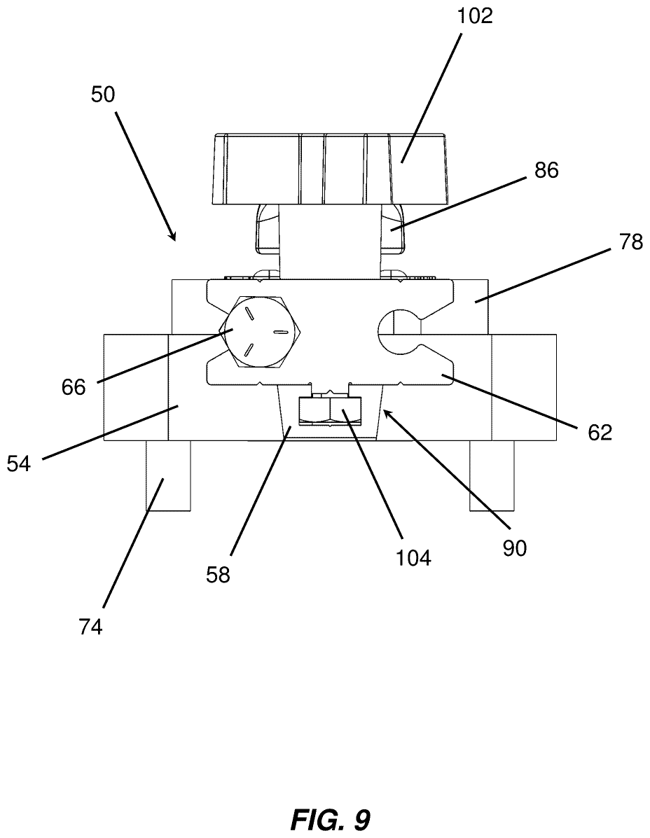

FIG. 6 shows a drawing of the T-track 58 and adjuster base 62 separate from the mounting base 54. The T-track 58 carries the adjuster base 62. The adjuster base 62 is attached to the T-track 58 with a bolt (104, FIG. 9) that passes through a hole in the adjuster base 62 and engages the central T-slot 106 in the T-track 58. The bolt head is located underneath the adjuster base 62 and the bolt head is positioned in the T-track slot 106. The threaded end of the bolt extends above the top of the adjuster base 62. A threaded nut/knob 102 is threaded onto the bolt end and is tightened against the adjuster base 62 to clamp the adjuster base 62 to the T-track 58 in a desired location. A threaded adjustment mechanism 72 extends laterally from the adjuster base 62 and is positioned between the adjuster base 62 and the mounting base 54 when the micro adjustment jig 50 is in use. The threaded adjustment mechanism 72 includes a threaded rod 66 which may be a bolt that is fastened to the adjuster base 62. In the example adjustment mechanism 72, the bolt 66 passes through a laterally extending hole in the adjuster base 62 and is attached to the adjuster base 62 in a fixed position with a nut 68. The threaded end of the bolt 66 extends to the right past the end of the adjustment base 62 and an internally threaded end stop 70 is threaded on to the protruding end of the threaded adjustment rod 66 formed by the end of the bolt 66. The end stop 70 is threaded onto the adjustment rod 66 to attach it to the adjustment rod 66 at a location where the end stop 70 overhangs the end of the threaded rod 66. The end stop 70 rotates freely on the threaded adjustment rod 66 with minimal resistance to increase or decrease the length of the adjustment mechanism 72 beyond the adjuster base 62 by changing the length by which the end stop 70 overhangs the end of the threaded rod 66.

The adjustment rod 66 and the end stop 70 form a micro adjustment mechanism 72 that extends between the mounting base 54 and the adjuster base 62 and that operates to precisely change the distance between the mounting base 54 and the adjuster base 62. During use, the end stop 70 is rotated relative to the adjustment rod 66 to move the end stop 70 along the threaded adjustment rod 66. As the end stop 70 overhangs the threaded rod 66, rotation of the end stop 70 changes the overhang of the end stop and the overall extended length of the adjustment mechanism 72. The adjustment mechanism 72 is kept in contact with the adjuster base 62 and the mounting base 54 so that changing its overall length also changes the distance between the adjuster base 62 and mounting base 54. In the example micro adjustment jig 50, the threaded rod 66 is attached to the adjuster base 62 and the distal end of the end stop 70 contacts the mounting base 54. Rotating the end stop 70 to change the distance between the adjuster base 62 and the end stop 70 changes the overall length of the micro adjuster 50 because the T-track 58 is attached to the adjuster base 62 by the bolt and threaded knob 102. The threaded knob 98 is typically kept somewhat loose during use and rotation of the end stop 70 changes the overall distance by which the T-track 58 extends from the mounting base 54.

In use, the distal end of the T-track 58 contacts the fence guide carriage 22 and moving the T-track in and out of the micro adjuster 50 allows the operator to precisely adjust the position of the table saw fence 10 relative to the saw blade 42. The thread pitch of the adjustment rod 66 and end stop 70 determines how far the T-track 58 moves with each turn of the end stop 70. A thread pitch of 16 threads per inch allows the operator to turn the end stop 70 one quarter turn to adjust the position of the fence 10 by 1/64 inch, or one sixth of a turn to adjust the position of the fence by 0.0104 or about one hundredth of an inch. A thread pitch of 18 threads per inch will move the fence position by approximately 0.055 inches, and rotation of the end stop 70 one sixth of a turn will move the fence by about 0.009, or about one hundredth of an inch. A thread pitch of 1 mm will move the fence about one hundredth of an inch for each quarter turn of the end stop 70. The end stop 70 may be marked to help a user keep track of how far they have rotated the end stop 70.

FIG. 6 shows how the T-track 58 slot 106 has T shaped profile that received a bolt head and is utilized to fasten the mounting base 54 and adjuster base 62 to the T-track 58. The ends of the T-track include smoothed or rounded corners to allow the T-track 58 to more easily slide in the mounting base slot 90.

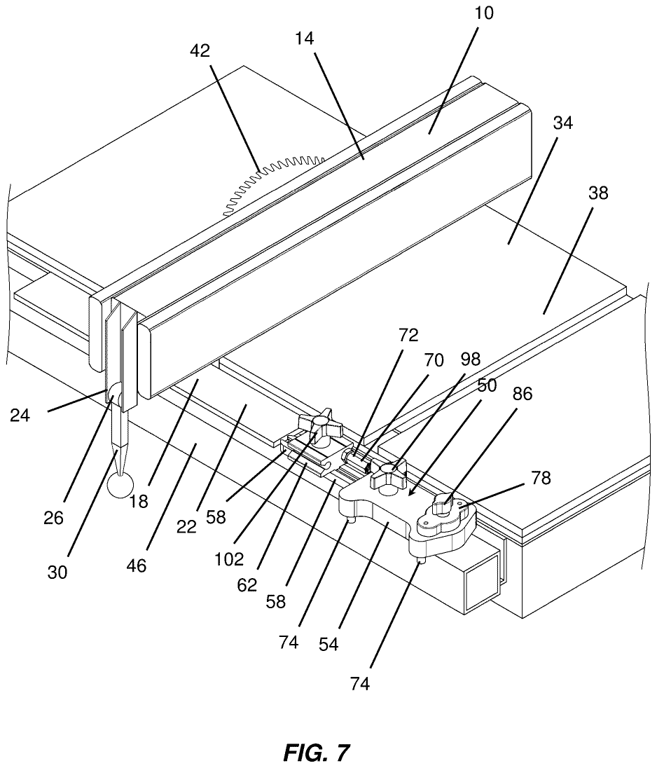

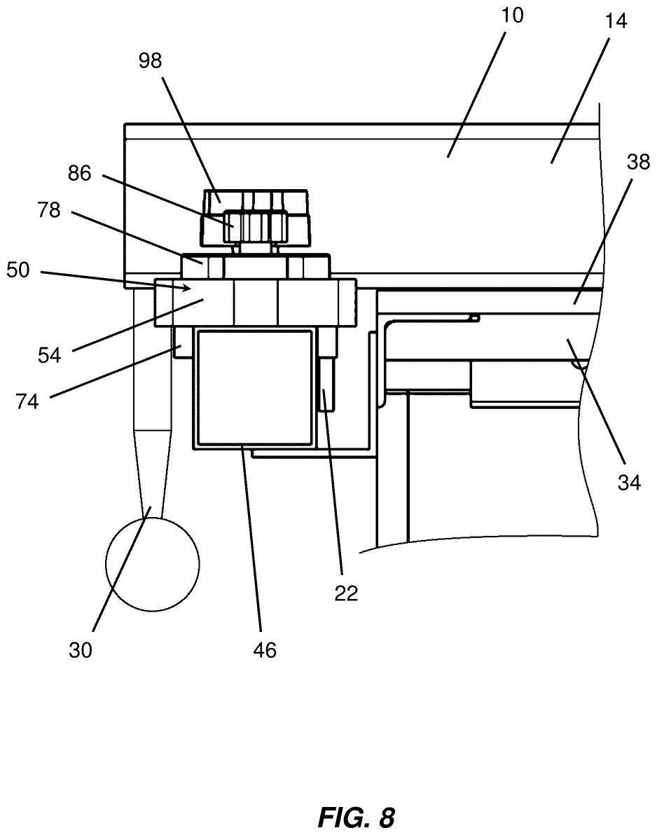

FIG. 7 shows a drawing of the micro adjustment jig 50 attached to the table saw 34. FIG. 8 shows an end view drawing of the micro adjustment jig 50 attached to the table saw 34. For clarity, some components are not visible in all views. The lower alignment guides 74 are used by the operator to align the micro adjustment jig 50 with the fence guide rail 46. A single lower alignment guide 74 may be positioned against the front of the fence guide rail 46 to align the jig 50 with the guide rail 46. The mounting base 54 rests on the top of the fence guide rail 46. When the jig 50 is in a desired position, the magnetic clamp 78 is actuated by turning the handle 86 to the on position to attach the micro adjustment jig 50 securely to the fence guide rail 46. Table saws 34 are commonly used with the blade 42 on the left side of the fence bar 14 and the micro adjustment jig 50 is usually attached to the fence guide rail 46 on the right side of the fence carriage 22. The micro adjustment jig 50 may be attached to the fence guide rail 46 on the left side of the fence carriage 22 if needed. Right handed users will typically cut with the blade 42 on the left side of the fence bar 14 and the micro adjustment jig 50 on the right side of the fence carriage 22. Left handed users may desire to cut with the blade 42 on the right side of the fence bar 14 and the micro adjustment jig 50 may be mounted to the fence guide rail 46 on the left side of the fence carriage 22 without any alteration of the micro adjustment jig 50. It can be seen how, in the more common application for the micro adjustment jig 50, the T-track 58 contacts the fence carriage 22. The mounting base 54 is attached to the fence guide rail 46 and is not moved while the T-track is extended or retracted from the mounting base 54 by adjusting the end stop 70 to thereby adjust the position the fence 10. Many fences are sufficiently heavy that the user may choose to move the fence away from the micro adjustment jig 50, adjust the micro adjustment jig 50 by extending or retracting the end stop and extension bar 58, and then moving the fence back in contact with the micro adjustment jig extension bar 58.

FIG. 9 shows an end view drawing of the micro adjustment jig 50. The micro adjustment jig 50 is identical to those discussed above except that the extension bar 58 has a trapezoidal or dovetail outer shape when viewed in a cross-section taken along the length of the extension bar 58. The top surface of the extension bar 58 is wider than the bottom surface of the extension bar so that the sides of the extension bar slope inwardly towards the bottom of the extension bar. Similarly, the upper surface of the slot 90 is wider than the lower opening of the slot 90 and the sides of the slot slope outwardly towards the upper surface of the slot. This tapered slot and extension bar 58 mechanically hold the extension bar 58 in the slot 90 while allowing the extension bar 58 to slide along the slot 90 to change the length of the extension bar 58 that extends from the mounting base 54.

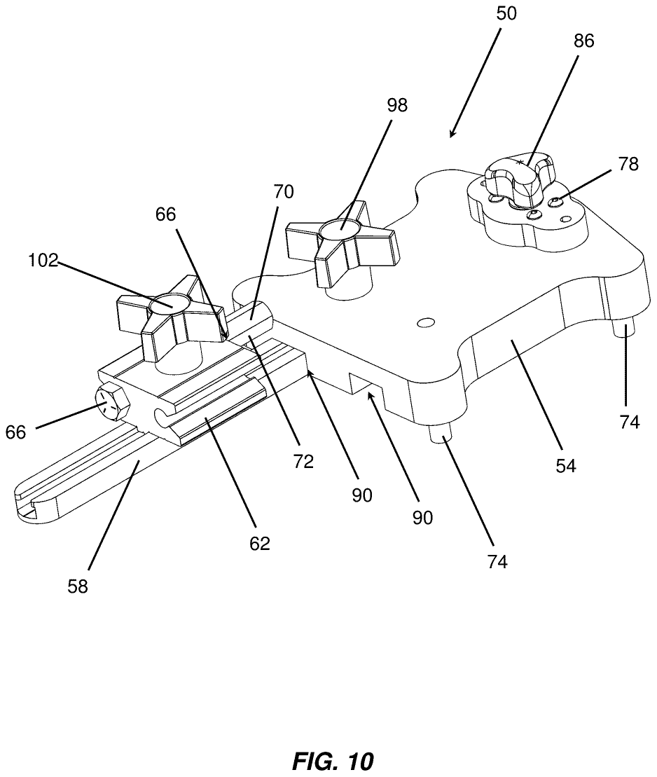

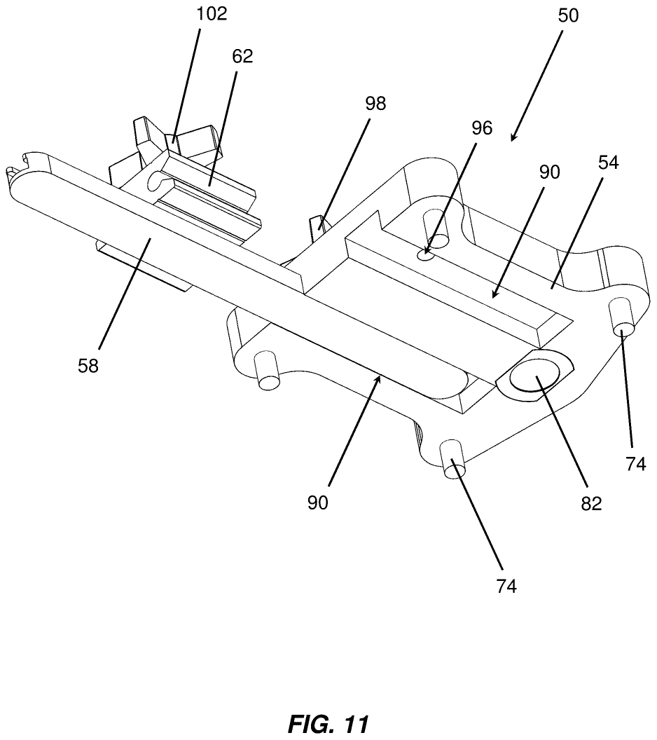

FIGS. 10 and 11 show perspective drawings of a micro adjustment jig 50. FIG. 10 shows an upper perspective view of the micro adjustment jig 50 while FIG. 11 shows a lower perspective view of the micro adjustment jig 50. The micro adjustment jig 50 is identical to those described above except that the mounting base 54 includes two slots 90 extending longitudinally along the length of the mounting base 54. Some table saws 34 include a fence 10 where the fence guide carriage 22 is not as wide as that shown in FIG. 7 or have a fence guide rail 46 that is significantly wider than that shown in FIG. 7. As a result, a micro adjustment jig 50 with the longitudinal guide slot 90 positioned along the center of the mounting base 54 may not reliably contact the fence guide carriage 22. To accommodate these table saws 34, the bottom of the mounting base 54 includes a first and a second longitudinal slot 90 and either slot may alternately receive the T-track extension bar 58. Both of the slots 90 are long enough to allow the T-track 58 to slide longitudinally along the slot 90 to change the distance by which the T-track 58 extends from the mounting base 54. A hand screw or a bolt and threaded nut/knob are used to attach the T-track 58 to the mounting base 54. In the example, a bolt 94 extends through a hole 96 in the mounting base 54 with the bolt head is positioned inside the slot 90 and the threaded end of the bolt 94 extending above the top of the mounting base 54. The bolt head is placed in the central slot of the T-track 58 when the T-track is inserted into the slot 90. A threaded knob 98 is attached to the threaded end bolt and can be used to secure the T track within the slot 90. Both slots 90 include a hole 96 that is centered within the width of the slot 90. The bolt 94 and threaded knob 98 are moved to the desired hole 96 according to which slot 90 the user needs to place the extension bar 58 into. Once the extension bar 58 is positioned within the slot properly, the threaded knob 98 is adjusted to hold the T-track within the slot 90 while allowing the T-track 58 to slide easily within the slot 90 to adjust the overall length of the micro adjuster 50 and thereby adjust the position of the table saw fence 10. The two slots 90 allow the micro adjustment jig 50 to be used reliably with table saws with a narrower fence guide carriage 22 on either side of the fence 10.

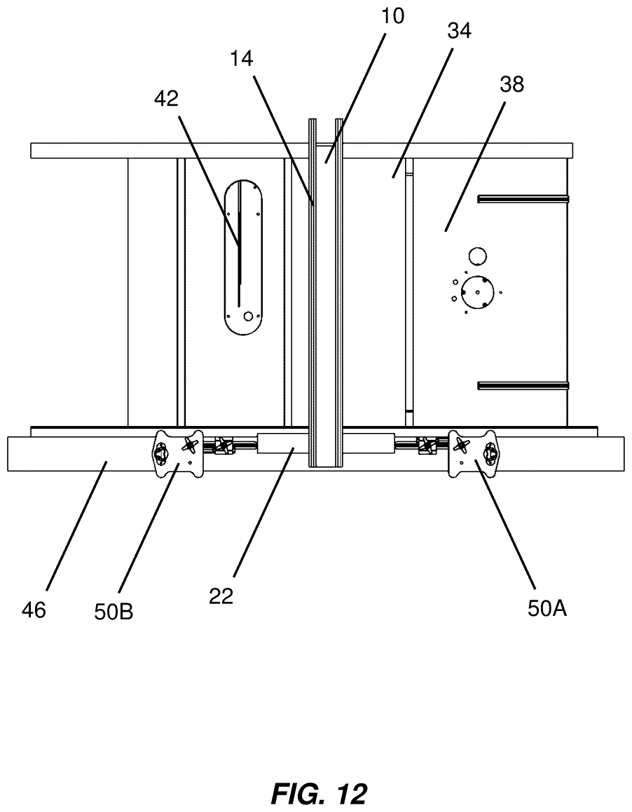

FIG. 12 shows a top view drawing of the micro adjustment jig 50 used with a table saw 34. As described above, the table saw 34 includes a fence guide carriage 22 that is narrower and only covers about half of the width of the fence guide rail 46. As such, a micro adjustment jig 50 which places the extension bar 58 along the center of the fence guide rail 46 positions the distal end of the extension bar 58 where it will not reliably contact the end of the fence carriage 22. Accordingly, a micro adjustment jig 50 with two guide slots 90 for the adjustment bar 58 is used. The mounting base 54 includes left and right guide slots 90 that are both oriented longitudinally along the mounting base 54. When a user desires to place the micro adjustment jig 50 to the right of the fence carriage 22 as shown at 50A, the adjustment bar 58 is placed into the right guide slot 90. In this configuration, the end of the extension bar 58 contacts the right end of the fence guide carriage 22. When a user desires to place the micro adjustment jig 50 to the left of the fence carriage 22 as shown at 50B, the adjustment bar 58 is placed into the left guide slot 90. In this configuration, the end of the extension bar 58 contacts the left end of the fence guide carriage 22. The micro adjustment jig 50 may thus be easily configured for use on either side of the fence carriage. While the micro adjustment jig 50 is shown in two positions 50A, 50B, it is appreciated that a single micro adjustment jig is used with the table saw 34.

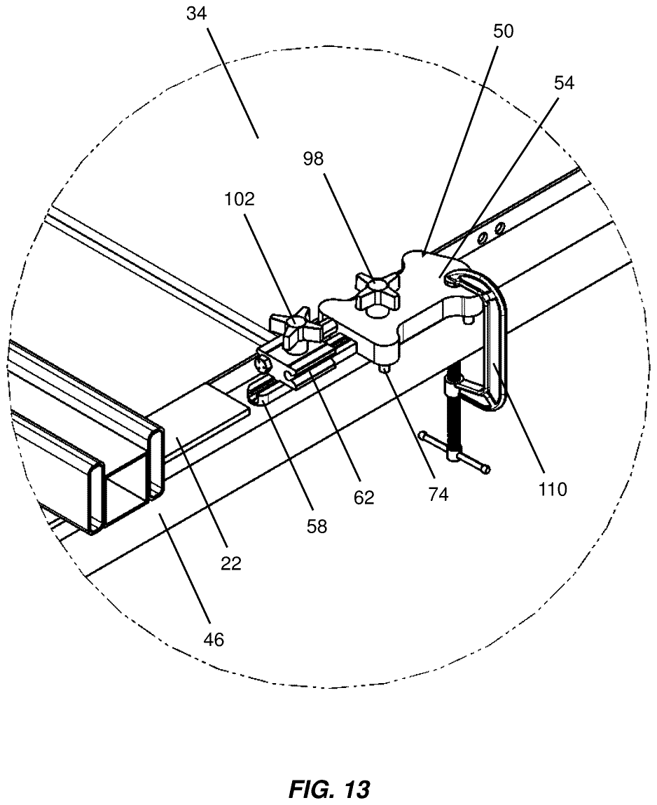

FIG. 13 shows a perspective drawing of the micro adjustment jig 50 used with a table saw having an aluminum fence guide rail 46. A magnetic clamp 78 will not work to clamp the micro adjustment jig on an aluminum guide rail 46. Accordingly, a mechanical clamp 110 such as a C-clamp is used to fasten the mounting base 54 to the guide rail 46. The micro adjustment jig is then used as described herein.

In use, the table saw fence 10 is moved as close as possible to the desired location to minimize the work necessary to adjust the fence position. Some table saws 34 include a ruler/scale attached to the table saw fence guide rail 46 and this guide can be used to position the fence 10. Alternatively, a direct measurement with a tape measure between the saw blade 42 and the fence bar 14 can be used to position the fence. The micro adjustment jig 50 is set up with the adjustment mechanism 72 set such that the end stop 70 can be moved inwardly or outwardly to adjust its length and with the adjuster base 62 attached securely to the T-track 58 with the adjustment mechanism contacting the mounting base 54. The T-track 58 is secured within the mounting base slot 90 with the bolt 94 and threaded knob 98 and adjusted such that the T-track is allowed to slide within the slot 90 without being overly loose. The user then places the micro adjustment jig 50 on the table saw fence guide rail 46. The user slides the micro adjuster 50 so that the end of the t-track 58 contacts the end of the table saw fence guide carriage 22. The user then engages the magnetic clamp 78 to lock the mounting base 54 to the guide rail 46 by rotating the switch handle 86. If necessary, the user loosens the threaded knob 98 on the mounting base 54 to allow the T-track 58 to move relative to the mounting base 54. The user then ensures that the end stop 70 contacts the mounting base 54, moving the adjuster base 62 if necessary, and tightens the threaded knob 102 to secure the adjuster base 62 to the T-track 58 so that the adjuster base 62 and T-track 58 move together.

With the micro adjuster 50 set up as discussed, the user takes a test cut and measures the test cut to determine what adjustment to the fence is necessary. Accurate measurement of the test cut can be accomplished by trying the test part on the assembly the actual part will be installed on, or it can be measured with an accurate measuring devise such a micrometer or a digital caliper or a tape measure or ruler. When the actual dimension of the test part is known, then it can be compared against the target dimension. For example, if the part needs to be 3.75 inches and the test part measures 3.783″, then the fence 10 needs to be moved 0.033″ toward the blade 42. If the thread on the micro adjuster adjustment mechanism 72 has a pitch of 18 threads per inch, one revolution of the end stop 70 will move the fence by 0.055 inches. The end stop 70 may include a hex nut, four or six sides or flats, or graduation lines on it. Rotating the end stop 70 one flat or one sixth of a revolution will move the end stop 70 (and hence the table saw fence) by 0.0092″. By rotating the end stop 70 3.5 flats (on the nut), it should move the fence 0.032″, within 0.001″ of the target. Accordingly, the user will loosen the fence clamp 24, rotate the end stop 70 a calculated amount to move the fence 10, and tighten the fence clamp 24 to lock the fence in the new position. If desired, the user may make another test cut and repeat the adjustment steps until an acceptable cut dimension is achieved. If the user initially cuts the piece of material slightly too big, they may recut the material after adjusting the fence position. If a fine thread is used on the adjustment mechanism 72, there is greater precision in making finer adjustments to the position of the fence 10. An adjustment of a few thousandths of an inch is possible by rotating the end stop 70 by a fraction of a turn. Many types of woodworking benefit from accurate cuts. Some projects such as building inlays or segments of assembled patterns or pieces for segmented turning particularly benefit from the ability to adjust the cut to very precise dimensions. These projects involve multiple precisely cut pieces fitted together and a smaller error in the size of the pieces results in a relatively large error in the overall assembly.

The micro adjustment jig 50 can also be used as a precise thin strip cutting jig for a table saw. In cutting thin strips, it is often desirable to cut the strip with the bulk material between the fence 10 and the blade 42 and the cutoff strip to the outside of the blade. This results in greater stability of the material while cutting and keeps the strip from becoming stuck between the fence and blade and becoming damaged or binding on the blade 42 and being thrown at the user by the blade 42. The micro adjustment jig 50 is placed on the left side of the table saw fence 10 (to the left of the blade 42) with the mounting base 54 to the left and the protruding end of the T-track 58 to the right of the micro adjustment jig 50. As an example, the micro adjustment jig 50 may be set up as follows. A straight edge is placed across the left side of the table saw blade 42 touching the blade teeth and a piece of wood is set between the fence bar 14 and the straight edge to set the position of the fence 10. The fence 10 is locked in place. This puts the wood in position with the left edge of the wood being aligned with the left edge of the blade 42, overlapping the wood with the thickness of the blade (its kerf). The same piece of wood is then placed against the fence carriage 22 and the micro adjustment jig 50 is placed against the wood so that the wood is positioned between the end of the micro adjustment jig T-track 58 and the left side of the fence carriage 22. The micro adjustment jig 50 is then adjusted to move the end of the T-track 58 to the left away from the fence carriage 22 and piece of wood by the thickness of the desired wood strip. If a 0.06 inch thick strip is desired, the jig end stop 70 is rotated to move it away from the mounting base 54 by 0.06 inches and thereby allow the T track to move 0.06 inches away from the fence carriage 22. The piece of wood is placed back between the end of the T-track 58 and the fence carriage 22 and the fence 10 is then moved so that the carriage 22 contacts the wood with the carriage 22 and the end of the T-track 58 both touching the wood. The wood is then cut with the table saw and a 0.06 strip is cut off. If the thickness is slightly off, an adjustment may be made to the micro adjustment jig 50.

The micro adjustment jig can also be set up by placing the fence 10 close to where it should be to cut a strip off of a piece of wood. The piece of wood is placed against the fence bar 14 and near the blade 42 to estimate the thickness of the strip that would be cut off of the piece of wood. The fence 10 is adjusted so that the cut strip of wood is visually correct. A ruler or caliper can be used to measure how far the piece of wood protrudes past the blade 42. The piece of wood can then be placed in contact with the left side of the fence carriage 22 and the micro adjustment jig 50 placed with the end of the T-track 58 in contact with the piece of wood. A first strip of wood is cut and measured, and the micro adjustment jig 50 is adjusted to eliminate any variance in the thickness of the strip of wood by rotating the end stop 70 to adjust the T-track 58.

Once the micro adjustment jig 50 is set up, the next strips are cut by leaving the micro adjustment jig 50 in place and adjusting the fence back towards the micro adjustment jig 50 by placing the piece of wood between the fence carriage 22 and end of the micro adjustment jig T-track 58 and adjusting the fence 10 over until the carriage 22, wood, and T-track 58 are in contact. This method of using the micro adjustment jig 50 cuts consistent strips of wood. While cutting, the micro adjustment jig 50 may remain locked in place and the reference point of the jig remains unchanged. The decreasing thickness of the wood is automatically accounted for as the fence is moved back against the jig T-track end and the wood. The reference point is at the base of the fence, so small angular deviations of the fence from perpendicular to the table rail while moving the fence 10 do not change the final locked in position of the fence. The cut strip of wood is not pinched between the table saw blade 42 and the fence bar 14, creating a potentially hazardous situation and damaging the cut strip. A left handed user may prefer to cut strips with the fence 10 on the left side of the blade 42. In this situation, the micro adjustment jig 50 may be placed on the right side of the blade 42 and fence carriage 22 and otherwise used as discussed above. When using the micro adjustment jig 50 as a thin strip cutting jig, the table saw blade 42 will typically be between the fence and the micro adjustment jig 50 regardless of which side of the blade 42 the fence 10 is located.

As discussed, the table saw fence micro adjustment jig 50 is used with the mounting body 54 attached to the saw. The adjuster base 62 is fixed to the t-track 58 by tightening the knob 102. As the end stop 70 is rotated, the extension bar 58 and adjuster base 62 move together relative to the mounting base 54, changing the position of the end of the extension bar 58 relative to the mounting base 54 and relative to the saw. With the clamp 78 engaged to attach the mounting base 54 to the saw 34 and the clamp 24 on the saw fence 10 disengaged, movement of the extension bar 58 push against the table saw fence 10 and accurately adjust the location of the fence. If adjustment of the jig and extension bar 58 creates a gap between the end of the extension bar 58 and the saw fence 10, the fence 10 can be manually moved until it comes in contact with the extension bar 58.

When unlocked for adjustment, table saw fences 10 typically rock back and forth by several degrees due to the clearance between the fence carriage 22 and the fence guide rail 46 and the drag of the fence bar 14 against the table 38 while moving the fence 10 laterally. When the fence is moved sideways to adjust the cut width, pushing the fence causes it to rotate a few degrees so it is no longer perpendicular to the fence guide rail 46. The fence 10 returns to perpendicular to the guide rail 46 when the clamp 24 is tightened, but the fence is no longer at the measured distance from the blade 42. The micro adjustment jig 50 adjusts the fence position at the carriage 22 at the proximal end of the table saw fence 10. This means that when the fence is clamped to the fence rail 46, the movement of the fence at the blade is the same as the adjustment made at the fence carriage 22. The design and mounting location of the micro adjustment jig 50 eliminates this inconsistency in setting up and adjusting the table saw fence 10 and significantly increases the accuracy that can be achieved in using the table saw 34. The micro adjustment jig 50 does not require modifications to the table saw and is usable with most table saws.

The micro adjustment jig 50 may also be used to preserve tool setups. In some situations, a user may need to return to a saw setup after making a different cut. For example, a user may need to change blades or make a different cut and then return to a previous fence position. The micro adjustment jig 50 may be positioned as a fence stop contacting the fence 10 at the position the fence must be returned to. The saw may then be adjusted to change blades or make the different cut. When desired, the fence may be returned to the preserved position by moving the fence back against the micro adjustment jig.

The above description of illustrated examples of the present invention, including what is described in the Abstract, is not intended to be exhaustive or to be limiting to the precise forms disclosed. While specific examples of the invention are described herein for illustrative purposes, various equivalent modifications are possible without departing from the broader scope of the present claims. Indeed, it is appreciated that specific example dimensions, materials, etc., are provided for explanation purposes and that other values may also be employed in other examples in accordance with the teachings of the present invention.

What is claimed is:

1. A table saw micro adjustment jig comprising:
a mounting base comprising:
a switchable magnetic clamp that is actuatable to magnetically attach the mounting base to a table saw fence guide rail at a fixed position;
a lower alignment guide that extends downwardly from a bottom of the mounting base, wherein the lower alignment guide is configured to contact the table saw fence guide rail in use to thereby align the mounting base with the fence guide rail;
a channel in the bottom of the mounting base;
a section of low profile T-track disposed in the channel and extending from the mounting base at a variable distance, wherein a distal end of the T-track is configured to contact a table saw fence to thereby adjust a position of a table saw fence;
a bolt having a head disposed in a T-track slot, a body extending through a hole in the mounting base, and a distal end;
a threaded knob that is operable to tighten the bolt to selectively prevent movement between the T-track and the mounting base;
an adjuster base attached to T-track;
an adjustment mechanism extending between the mounting base and the adjuster base comprising:
an externally threaded rod;
an internally threaded end stop rotatably attached to the threaded rod such that rotation of the end stop moves the end stop along a length of the threaded rod and thereby changes a length of the adjustment mechanism and a distance between the mounting base and a distal end of the T-track.

2. The jig of claim 1, wherein an active end of the magnetic clamp is disposed at a bottom face of the mounting base.

3. The jig of claim 1, wherein the externally threaded rod is attached to the adjuster base and wherein the end stop contacts the mounting base.

4. The jig of claim 1, wherein the externally threaded rod comprises a bolt that passes through a hole in the adjuster base and is attached to the adjuster base with a nut and wherein a distal end of the bolt extends towards the mounting base.

5. The jig of claim 1, wherein the adjuster base is releasably attachable to the T-track at different locations along a length of the T-track.

6. The jig of claim 1, wherein the adjuster base is releasably attached to the T-track by a bolt having a head disposed in the T-track slot and a bolt body extending through the adjuster base and a threaded knob attached to the bolt.

7. The jig of claim 1, wherein the lower alignment guide extends longitudinally along the bottom of the mounting base in a direction parallel to the T-track.

8. A table saw micro adjustment jig comprising:
a mounting base having a clamp configured to attach the mounting base to a table saw;
a channel extending through the mounting base;
an extension bar disposed in the channel and extending from the mounting base, wherein a distal end of the extension bar is configured to contact a table saw fence to thereby adjust a position of a table saw fence, and wherein the extension bar is slidable within the channel to adjust a length of the extension bar which extends past the mounting base;
an adjuster base attached to the extension bar;
an adjustment mechanism extending between the mounting base and the adjuster base comprising:
an externally threaded rod;
an internally threaded end stop rotatably attached to the threaded rod such that rotation of the end stop moves the end stop along a length of the threaded rod and thereby changes a length of the adjustment mechanism and a distance between the mounting base and the adjuster base.

9. The jig of claim 8, wherein the clamp comprises a switchable magnetic clamp that is actuatable to magnetically attach the mounting base to the table saw.

10. The jig of claim 8, further comprising a lower alignment guide that extends downwardly from a bottom of the mounting base, wherein the lower alignment guide is configured to contact a table saw fence guide rail in use to thereby align the mounting base with the fence guide rail.

11. The jig of claim 10, wherein the lower alignment guide extends along the bottom of the mounting base in a direction parallel to the T-track.

12. The jig of claim 10, wherein the lower alignment guide comprises two posts extending downwardly from the mounting base.

13. The jig of claim 8, wherein the extension bar comprises a section of bar having a T shaped slot formed along a length thereof, and wherein the mounting base comprises a bolt having a head disposed in the slot, a body extending through a hole in the mounting base, and a distal end, and wherein the mounting base comprises a threaded nut that is operable to tighten the bolt to selectively prevent movement between the T-track and the mounting base.

14. The jig of claim 8, wherein lengthening the adjustment mechanism moves the adjuster base away from the mounting base and thereby moves the extension bar away from the mounting base.

15. A micro adjustment jig comprising:
a mounting base configured for attachment to a saw;
a mounting base channel;
an extension bar disposed in the channel and extending from the mounting base, wherein the extension bar is slidable within the channel to adjust a length of the extension bar which extends past the mounting base, and wherein a distal end of the extension bar comprises a contact point used to adjust a length of cut made by the saw;
an adjuster base attached to the extension bar;
an adjustment mechanism extending between the mounting base and the adjuster base and contacting the mounting base and the adjustment base comprising:
an externally threaded rod;
an internally threaded end stop rotatably attached to the threaded rod such that rotation of the end stop changes a position of the end stop along the threaded rod to thereby change a length of the adjustment mechanism and thereby change a distance between the mounting base and the adjuster base and a length of the extension bar that extends from the mounting base.

16. The jig of claim 15, further comprising a switchable magnetic clamp that is attached to the mounting base and that is actuatable to magnetically attach the mounting base to the saw.

17. The jig of claim 15, further comprising a lower alignment guide that extends downwardly from a bottom of the mounting base, wherein the lower alignment guide is oriented parallel to the extension bar and configured to contact the saw when the jig is in use to thereby align the mounting base to the saw.

18. The jig of claim 15, wherein the extension bar comprises a section of bar having a T shaped slot formed along a length thereof, and wherein the mounting base comprises a bolt having a head disposed in the slot, a body extending through a hole in the mounting base, and a distal end, and wherein the mounting base comprises a threaded nut that is operable to tighten the bolt to selectively prevent movement between the T-track and the mounting base.

19. The jig of claim 15, wherein the externally threaded rod is attached to the adjuster base and wherein the end stop extends past an end of the externally threaded rod and contacts the mounting base.

20. The jig of claim 15, wherein the adjuster base is releasably attachable to the extension bar at different locations along a length of the extension bar.
